(19) United States
(12) Patent Application Publication
(10) Pub. No.: US 2009/0140937 A1
(43) Pub. Date: Jun. 4, 2009

(54) Slot antenna used in a desktop computer

(75) Inventors: John Chow, Saratoga, CA (US); Li-Chun Wu, Tu-cheng (TW); Der-Chung Hwang, Tu-cheng (TW); Yun-Cheng Hou, Tu-cheng (TW); Wen-Zhao Huang, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/315,394

(22) Filed: Dec. 3, 2008

(30) Foreign Application Priority Data
Dec. 3, 2007 (CN) 200720131187.4

(51) Int. Cl. H01Q 1/24; H01Q 13/10

(52) U.S. Cl. 343/702; 343/767

(57) ABSTRACT

An antenna unit is used in a desktop computer (100) having a metal shell (1). The antenna unit includes a slot (110) defining on the metal shell, a coaxial cable (3) having an inner conductor (32) connected to a first side (111) of the slot and an outer braiding (33) connected to a second side (112) of the slot, and a fastening member (34) extending across the coaxial cable and securing the coaxial cable on the metal shell.

### BACKGROUND OF THE INVENTION

1. Field of the Invention

The present invention relates to an antenna, and more particularly a slot antenna unit used in a desktop computer.

2. Description of the Prior Art

With current developments in communication technology, such as Wireless Local Area Network (WLAN), Bluetooth and HomeRF, many desktop computers now have the function of wireless telecommunication. To achieve this function, an antenna is used with a desktop computer for receiving and transmitting signals. One conventional antenna used with a WLAN card having a Peripheral Component Interconnect (PCI) interface is externally mounted. The WLAN card is mounted in a PCI expansion slot in a desktop computer with a bracket covering a corresponding slot in a back cover of an enclosure of the desktop computer. The antenna is mounted to an exterior side of the bracket and electrically connects with the WLAN card through the bracket. However, the antenna is exposed to an outside of the enclosure and can be easily damaged, so the performance of the antenna is not really reliable.

Hence, an improved desktop computer is needed to solve the above problem.

### BRIEF SUMMARY OF THE INVENTION

One object of the present invention is to provide an antenna unit used in a desktop computer for effectively receiving and transmitting a signal.

The present invention provides an antenna unit used in a desktop computer having a metal shell. The antenna unit comprises a slot defined on the metal shell, a coaxial cable comprising an inner conductor connected to a first side of the slot and an outer braiding connected to a second side of the slot, and a fastening member extending across the coaxial cable and securing the coaxial cable on the metal shell.

Advantages of the present invention are to provide an antenna unit having a slot defined on a metal shell of the desktop computer and cooperated with a coaxial cable for reliably and effectively receiving and transmitting a signal.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is a perspective view of a desktop computer in accordance with the present invention;

FIG. 2 is a perspective view showing a slot antenna unit on a metal shell of the desktop computer; and

FIG. 3 is an enlarged view of the slot antenna unit showing in FIG. 2.

### DETAILED DESCRIPTION OF THE INVENTION

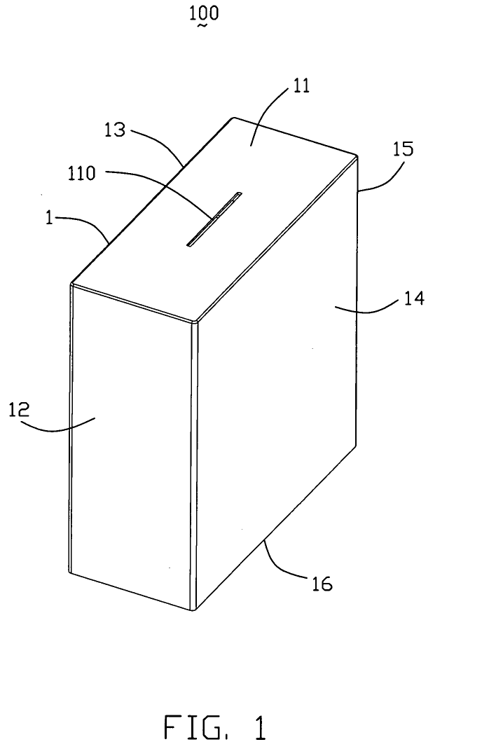

Reference will now be made to the drawing figures to describe the present invention in detail. Referring to FIGS. 1-3, a desktop computer 100 comprises a metal shell 1 defining an interior space 17, a printed circuit board 2 located into the interior space 17 and a coaxial cable 3 connected to the printed circuit board 2. The metal shell 1 has a plurality of electronic components (not shown) mounted thereon.

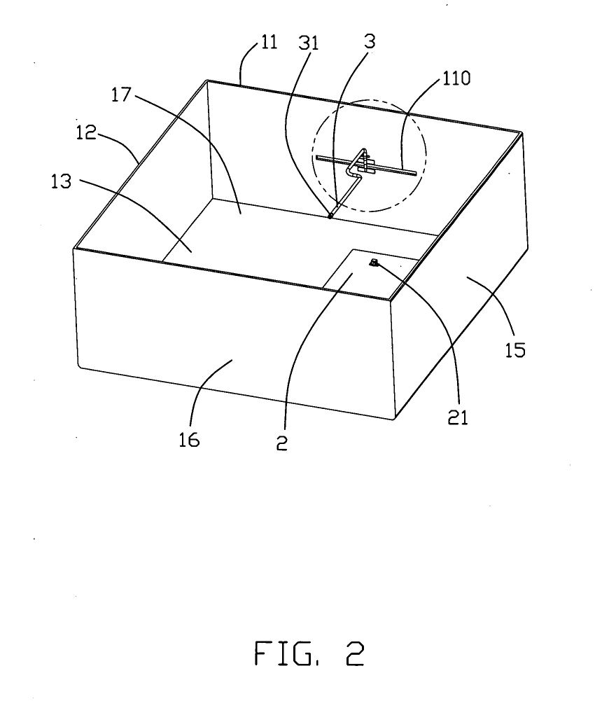

Referring to FIGS. 1 and 2, the metal shell 1 has a top wall 11 defining a slot 110, a bottom wall 16 and a plurality of side walls 12. The desktop computer 100 further comprises a fastening member 34 extending across the coaxial cable 3 for fastening the coaxial cable 3 to an inner surface of the metal shell 1. The fastening member 34 is assembled to the metal shell 1 by a pair of screws (not labeled).

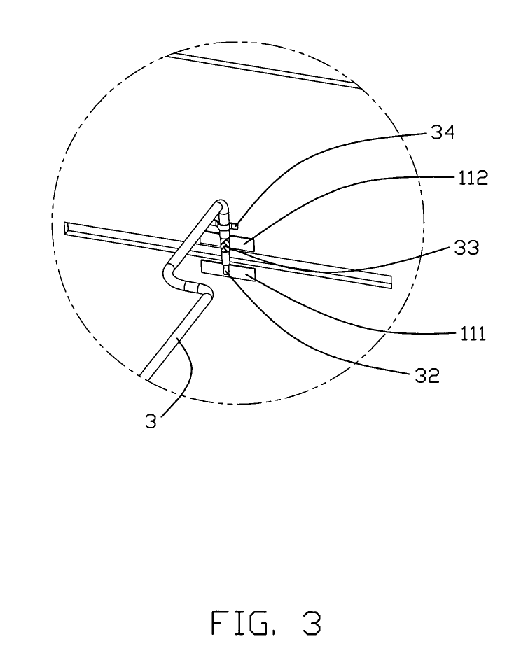

Referring to FIGS. 2 and 3, the printed circuit board 2 is mounted to one side wall 12 of the metal shell 1. In another embodiment, the printed circuit board 2 could be replaced by a WLAN card. The desktop computer 100 comprises an RF (Radio Frequency) connector 31 mounted to the printed circuit board 1. The coaxial cable 3 comprises one end 31 connected to the RF connector 31 and an inner conductor 32 extending across the slot 110 along a lengthwise direction for receiving and transmitting a signal.

The coaxial cable 3 comprises an inner conductor 32 secured to a first side 111 of the slot 110, a first insulator (not labeled) surrounding the inner conductor 32, an outer braiding 33 terminated to a second side 112 of the slot 110 for grounding and a second insulator (not labeled) packaging the outer braiding 33. The coaxial cable 3 is attached to the metal shell 1 by a fastening member 34 and cooperates with the slot 110 for serving as an antenna unit for transmitting and receiving signals.

The length of the slot 110 is 120 diameter and the height of slot 110 is 5 diameter. The shape of the slot 110 confirms to operating in a frequency band of 2.5 GHz. Note that each radiation pattern is close to a corresponding optimal radiation pattern and there is no obvious radiating blind area.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An antenna unit used in a desktop computer having a metal shell, comprising:
a slot defining on the metal shell;
a coaxial cable comprising an inner conductor connected to a first side of the slot and an outer braiding connected to a second side of the slot; and
a fastening member extending across the coaxial cable and securing the coaxial cable on the metal shell.

2. The antenna unit as claimed in claim 1, further comprising a pair of screws for assembling the fastening member to the metal shell.

3. A desktop computer, comprising:
a metal shell having a plurality of walls defining an interior space;
a slot slotted in one of the wall;
a coaxial cable received in the interior space and comprising an inner conductor and an outer braiding, the coaxial cable attached to an inner face of the wall and extending across the slot with the inner conductor electrically connecting to a first side of the slot, and the outer braiding electrically connecting to a second side of the slot.

4. The desktop computer as claimed in claim 3, further comprising a printed circuit board located in the interior space, one end of the coaxial cable is connected to the printed circuit board.

5. The desktop computer as claimed in claim 4, further comprising an RF (Radio Frequency) connector mounted to the printed circuit board, the end of the coaxial cable electrically connected to the RF connector.

6. The desktop computer as claimed in claim 3, further comprising a fastening member extending across the coaxial cable for securing the coaxial cable to the inner face of the metal shell.

7. The desktop computer as claimed in claim 6, wherein said fastening member is assembled to the metal shell by a pair of screws.

8. A computer assembly comprising:
a metallic computer case enclosing a space in which a mother board is disposed;
a plate of said computer case defining an elongated slot along a lengthwise direction with two opposite closed type ends; and
a coaxial cable having an inner conductor mechanically and electrically connected by one elongated side of the slot, and an outer conductor mechanically and electrically connected to the other elongated side of the slot; wherein
said coaxial cable is fastened to a middle point of said slot in said lengthwise direction.

9. The computer assembly as claimed in claim 8, wherein said slot is essentially located in a middle portion of the plate.

10. The computer assembly as claimed in claim 8, wherein said slot extends parallel to the mother board.

11. The computer assembly as claimed in claim 10, wherein said mother board is equipped with an RF (Radio Frequency) connector, and the coaxial cable is connected thereto.

12. The computer assembly as claimed in claim 8, wherein said plate is of a rectangle having a long side and a short side, and said slot extends parallel to the long side.
